(19) United States
(12) Patent Application Publication
(10) Pub. No.: US 2026/0111739 A1
(43) Pub. Date: Apr. 23, 2026

(54) Time Series Anomaly Detection Using Temporal Correlation Weights

(71) Applicant: Fujitsu Limited, Kawasaki-shi (JP)

(72) Inventors: Supriya BAJPAI, Bangalore (IN); Niraj KUMAR, Bangalore (IN)

(73) Assignee: Fujitsu Limited, Kawasaki-shi (JP)

(21) Appl. No.: 19/193,155

(22) Filed: Apr. 29, 2025

(30) Foreign Application Priority Data
Oct. 18, 2024 (IN) 202411079402

(51) Int. Cl. G06N 3/088; G06N 3/0455

(52) U.S. Cl. CPC G06N 3/088; G06N 3/0455

(57) ABSTRACT

In an embodiment, a method is provided for time series anomaly detection using temporal correlation weights. The method involves receiving a dataset to prepare a data input for a neural network with first decoder, second decoder, and encoder. Temporal embeddings and sampling temporal correlation weights are generated from the data input. Further, anomalous time series data is reconstructed by applying the first decoder to the temporal embeddings. The method further involves generating a first discriminator output by applying the second decoder to the temporal embeddings and feeding the anomalous time series data to the encoder to produce anomalous temporal embeddings and correlation weights. A second discriminator output is generated by applying the second decoder to the anomalous temporal embeddings. The method computes divergence loss between the sampled and anomalous temporal correlation weights, as well as reconstruction losses based on the data input and discriminator outputs, to train the neural network.

### CROSS REFERENCE TO RELATED APPLICATION

This application is based upon and claims the benefit of priority of Indian Patent Application No. 202411079402 filed on Oct. 18, 2024, the entire contents of which are incorporated herein by reference.

### FIELD

The embodiments discussed in the present disclosure are related to time series anomaly detection using temporal correlation weights.

### BACKGROUND

Network anomaly detection and intrusion detection systems are essential for safeguarding network resources and sensitive data from malicious activities. These systems commonly analyze large volumes of time series data from multiple sensors to identify potential threats. Traditional methods frequently depend on supervised learning techniques, which necessitate labeled training data. However, obtaining labeled data can be costly and time-consuming to obtain in real-world scenarios.

To address the above limitation, Unsupervised or semi-supervised anomaly detection techniques without relying on the labeled data have emerged as a promising alternative, but face challenges in accurately identifying subtle anomalies and handling unlabeled mixed data containing both normal and anomalous samples. Existing methods such as transformer-based autoencoders, spatial-temporal graph attention networks, and GAN-based approaches struggle to achieve high accuracy in detecting anomalies, particularly when dealing with complex temporal correlations and inter-feature relationships in multivariate time series data. There is a need for improved techniques that can increase detection accuracy for subtle anomalies while effectively handling unlabeled mixed data in network intrusion detection scenarios.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include a set of operations which may include receiving a dataset comprising time series data. The set of operations may further include preparing, based on the dataset, a data input for a neural network (NN) comprising a first decoder, a second decoder, and an encoder connected to both the first decoder and the second decoder. The set of operations may further include generating, by applying the encoder to the data input, temporal embeddings and sample temporal correlation weights of the data input. The set of operations may further include reconstructing anomalous time series data by applying the first decoder to the temporal embeddings and generating a first discriminator output by applying the second decoder to the temporal embeddings. The set of operations may further include feeding the anomalous time series data to the encoder to output anomalous temporal embeddings and anomalous temporal correlation weights of the anomalous time series data. The set of operations may further include generating a second discriminator output by applying the second decoder to the anomalous temporal embeddings and computing a divergence loss between the sample temporal correlation weights and the anomalous temporal correlation weights of the anomalous time series data. The set of operations may further include computing reconstruction losses based on the data input, the anomalous time series data, the first discriminator output, and the second discriminator output and training the neural network based on the divergence loss and the reconstruction losses.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example environment related to time series anomaly detection using temporal correlation weights;

FIG. 2 is a block diagram that illustrates an exemplary system for time series anomaly detection using temporal correlation weights;

FIGS. 3A to 3C are diagrams that collectively illustrate a flow chart of an example method for automated machine learning training and inference of time series anomaly detection using temporal correlation weights;

FIG. 4 is a diagram that illustrates an exemplary architectural diagram of the system for time series anomaly detection using temporal correlation weights;

FIG. 5 is a diagram that illustrates an exemplary Network-based Intrusion Detection System (NIDS); and

FIG. 6 is a diagram that illustrates a flowchart of an example for time series anomaly detection using temporal correlation weights.

The drawings are useful in explaining at least one embodiment described in the present disclosure.

### DESCRIPTION OF EMBODIMENTS

Some embodiments described in the present disclosure may relate to methods and systems for time series anomaly detection using temporal correlation weights. In the present disclosure, a dataset may be received by the system. The received dataset comprises time series data, which may be unlabeled data in a form of multivariate time series. In some instances, the received dataset may be a mix of anomalous and non-anomalous data. Based on the received dataset, a data input for a neural network (NN) may be prepared. The neural network may include a first decoder, a second decoder, and an encoder connected to both the first decoder and the second decoder. The preparation of the data input may include performing data imputation on the time series data to obtain refined time series data. Further, the refined time series data may be divided into windows of the refined time series data, wherein the data input includes the windows of the refined time series data. Temporal embeddings and sample temporal correlation weights of the data input may be generated based on application of encoder to the data input. The application of encoder to the data input includes generation of graph embeddings with dynamic inter-feature correlations based on the data input and feeding of the graph embeddings with the dynamic inter-feature correlations into an attention layer of the encoder to generate the temporal embeddings and the sample temporal correlation weights. The temporal embedding may be a graph temporal embedding, the sample temporal correlation weights may be the sample temporal graph correlation weights, and the attention layer may have a self-attention mechanism.

Anomalous time series data may be reconstructed by applying the first decoder to the temporal embeddings. A first discriminator output may be generated by applying the second decoder to the temporal embeddings. Further, the anomalous time series data may be fed to the attention layer of the encoder to output anomalous temporal embeddings and anomalous temporal correlation weights of the anomalous time series data. The anomalous temporal embeddings are anomalous graph temporal embeddings, and the anomalous temporal correlation weights are anomalous temporal graph correlation weights. Further, a second discriminator output may be generated by applying the second decoder to the anomalous temporal embeddings. A divergence loss between the sample temporal correlation weights and the anomalous temporal correlation weights of the anomalous time series data may be computed. Further, reconstruction losses may be computed based on the data input, the anomalous time series data, the first discriminator output, and the second discriminator output. Furthermore, the neural network may be trained based on the divergence loss and the reconstruction losses.

Conventional methods for detecting anomalous data may involve learning of a pointwise and a pairwise representation based on training only non-anomalous data. Conventional method may not include differentiable criteria, and when the differentiable criteria is included, the divergence is between the non-anomalous temporal weights and a prior assumption. However, detecting anomalous data from an unlabeled time series data may present several challenges:
1. Human error: Manual anomalous data and non-anomalous data shorting or monitoring may be prone to errors, potentially leading to inaccurate data and costly mistakes.
2. Time-intensive processing: Manually processing large volumes of data may reduce efficiency and productivity.
3. Data format inconsistencies: anomalous data and non-anomalous data may be in various formats, making manual integration and standardization complex and error prone.
4. Real-time processing requirements: unlabeled time series data may need to be processed in real-time to be useful, which manual management may struggle to achieve.

The present disclosure may address these challenges by detecting anomalies in time series data using temporal correlation weights. This approach may enable more efficient, accurate, and timely processing of one or more datasets, leading to improved management and optimization of detection of anomaly in time series data.

The technological field of time series anomaly detection may be improved by configuring a system to detect anomaly in time series data using temporal correlation weights. The system may receive a dataset comprised of a time series data and prepare a data input for a NN. The system generates temporal embeddings and sample temporal correlation weights of the data input and reconstructs anomalous time series data. Further, the system generates a first discriminator output and feeds the anomalous time series data to the output anomalous temporal embeddings and anomalous temporal correlation weights. The system generates a second discriminator output and computes a divergence loss between the sample temporal correlation weights and the anomalous temporal correlation weights. Also, the system computes, reconstruction losses and trains the neural network based on the divergence loss and the reconstruction losses.

The approach may offer several advantages:
1. The system may be trained to minimize the reconstruction error of input data sample.
2. The system may be trained to maximize the reconstruction error of the generated anomalous data.
3. The system may be trained to increase the difference between anomalous and non-anomalous data samples (differentiable criteria).
4. The system may use self-attention mechanism to estimate correlation weights as the distribution of correlation weights is not known and the system may have access to anomalous data that is generated from a generator. The use of the self-attention mechanism eliminates the requirement of assuming that the distribution of anomalous data follows any known distribution (such as gaussian distribution).
5. The system may compute divergence loss that may be used to estimate and increase the divergence/differentiability between anomalous temporal correlations and non-anomalous temporal correlations.
6. The system exhibits higher accuracy due to strong differentiation between anomalous and non-anomalous data that may detect subtle anomalies effectively.
7. The system detects the distinctive features of anomalous and non-anomalous data.
8. The system trained with unlabeled network time series data detects anomalous data with high accuracy.
9. The system computes total loss that improves the decision-making of the neural network based on the training.
10. The system increases the accuracy by increasing the possibility of detecting subtle anomalies and allows the neural network to train with mixed data.

Embodiments of the present disclosure are explained with reference to the accompanying drawings.

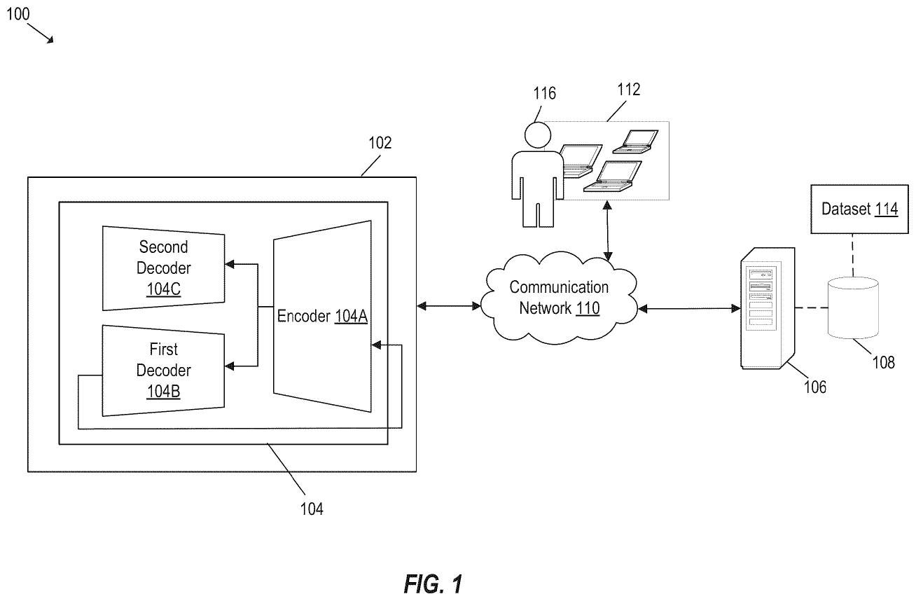

FIG. 1 is a diagram representing an example environment related to time series anomaly detection using temporal correlation weights, arranged in accordance with at least one embodiment described in the present disclosure. With reference to FIG. 1, there is shown an environment 100. The environment 100 may include a system 102, a neural network 104, a remote server 106, a relational database 108, a communication network 110, and a user device 112 associated with a user 116.

The system 102 may include suitable logic, circuitry, and interfaces that may be configured to train the neural network 104 using a training dataset (for example, the dataset 114) of multivariate time series data. Once trained, the neural network 104 may be deployed on the system 102 for inference or real/near-real time series forecasting. The system 102 may be further configured to detect anomalies in unseen data (i.e., multi-variate time series data that is not used in the training of the neural network 104) using the trained neural network 104. Examples of the system 102 may include, but are not limited to, a computing device, a hardware-based annealer device, a digital-annealer device, a quantum-based or quantum-inspired annealer device, a smartphone, a cellular phone, a mobile phone, a gaming device, a mainframe machine, a server (or a cluster of servers), a computer workstation, and/or a consumer electronic (CE) device.

The neural network 104 may be a generative time series network that may be trained based on adversarial learning approach for anomaly detection in time series data. The neural network 104 may consist of two virtual autoencoders (also referred to as ED1 and ED2), which share a common encoder (referred to as the encoder 104A (E)). The two virtual autoencoders may include the first decoder 104B, the second decoder 104C, and the encoder 104A connected to both the first decoder 104B and the second decoder 104C. The encoder 104A and the first decoder 104B may together form a generator network, and the encoder 104A and the second decoder 104C may together form a discriminator network. The autoencoders may determine spatial and temporal dependency between features of the dataset 114. The spatial and temporal dependency may be used for anomaly detection, classification, or other applications.

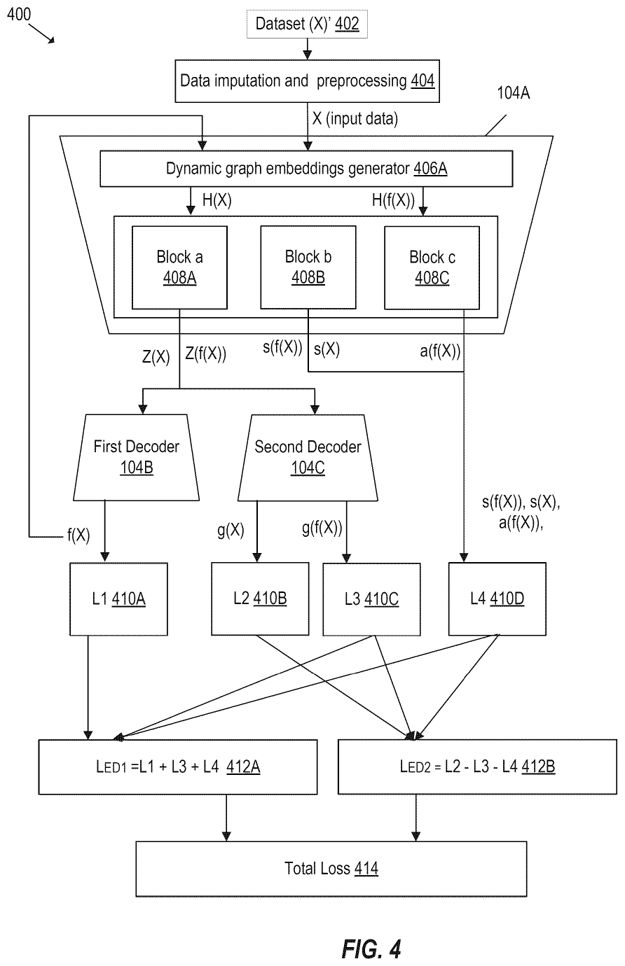

The encoder 104A may be applied to the data input to generate temporal embeddings (such as graph temporal embeddings) with dynamic inter-feature correlations based on the data input. The encoder 104A may include an attention layer, which receives the temporal embeddings with the dynamic inter-feature correlations to generate the temporal correlation weights for sample and anomalous data. In an embodiment, the encoder 104A may include a graph embedding generation block (for example, dynamic graph embedding generator 406A in FIG. 4), a temporal embedding block (for example, block “a” 408A in FIG. 4), a temporal correlation weights block (for example, block “b” 408B in FIG. 4), and an anomalous temporal correlation weights block (for example, block “c” 408C in FIG. 4).

The first decoder 104B may be configured to reconstruct the anomalous data from latent representations (temporal embeddings) generated by the encoder 104A. The first decoder 104B may consist of a plurality of Multilayer Perceptron (MLP) layers (or fully connected layers) and may be referred to as an MLP decoder. These MLP layers may transform the temporal embeddings back into the original feature space.

The second decoder 104C may be configured to reconstruct the time series data from latent representations (temporal embeddings) generated by the encoder 104A. Similar to the first decoder 104B, the second decoder 104C may consist of a plurality of MLP layers (or fully connected layers) and may be referred to as an MLP decoder. These MLP layers may transform the temporal embeddings back into the original feature space.

Each of the encoder 104A, the first decoder 104B, and the second decoder 104C combined may be referred to as a neural network. In general, such a neural network may be referred to as a computational network or a system of artificial neurons, arranged in a plurality of layers. The plurality of layers of the neural network may include an input layer, one or more hidden layers, and an output layer. Each layer of the plurality of layers may include one or more nodes (or artificial neurons, for example). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before or after training the neural network on a training dataset (such as the dataset 114).

Each node of the neural network may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to the same or a different mathematical function.

In an embodiment, the training of the neural network 104 may include updating weight parameters of the encoder 104A (e.g., the graph embedding generation block such as dynamic graph embedding generator 406A in FIG. 4, temporal embedding block (for example, block “a” 408A in FIG. 4), temporal correlation weights block (for example, block “b” 408B in FIG. 4), and anomalous temporal correlation weights block (for example, block “c” 408C in FIG. 4)), the first decoder 104B, and the second decoder 104C.

In training of the neural network 104, one or more parameters of each node of the neural network 104 may be updated based on whether an output of the neural network for a given input (from the training dataset) matches a correct result based on a loss function (for example, loss function to calculate the divergence loss or the reconstruction losses) for the neural network 104. The above process may be repeated for the same or a different input until a minima of loss function is achieved, and a training error is minimized. Several methods for training are known in art, for example, gradient descent, stochastic gradient descent, batch gradient descent, gradient boost, meta-heuristics, and the like.

In an embodiment, the neural network may include electronic data, which may be implemented as, for example, a software component of an application executable on the system 102. The neural network may rely on libraries, external scripts, or other logic/instructions for execution by a processing device, such as the system 102. The neural network may include code and routines configured to enable a computing device, such as the system 102 to perform one or more operations for anomaly score computation from time series data. Additionally, or alternatively, the neural network may be implemented using hardware including a processor, a microprocessor (e.g., to perform or control performance of one or more operations), a field-programmable gate array (FPGA), or an application-specific integrated circuit (ASIC). Alternatively, in some embodiments, the neural network may be implemented using a combination of hardware and software.

The remote server 106 may include logic, interfaces, and/or code configured to store the dataset 114 comprising a time series database, or the data input that may be prepared based on the dataset 114. The time series data may be unlabeled data in a form of multivariate time series. In certain instances, the remote server 106 may be configured to retrieve from the relational database 108, the dataset 114 stored as records in table of relational database 108. In at least one embodiment, the remote server 106 may be implemented as a plurality of distributed cloud-based resources by use of several technologies that are well known to those ordinarily skilled in the art. In certain embodiments, the functionalities of the remote server 106 may be incorporated in its entirety or at least partially in the system 102, without a departure from the scope of the disclosure.

The relational database 108 may be stored or cached on a device such as a remote server 106 or the system 102. The relational database 108 may store the dataset 114 comprising time series data or a data input (that may be prepared based on the dataset 114) in form of a table or a group of tables in the relational database 108. The received time series data may be unlabeled data in a form of multivariate time series and may be referred to a mix of anomalous data and non-anomalous data. The relational database 108 may be hosted on multiple servers at the same or different locations. Operations of the relational database 108 may be executed using hardware including a processor, a microprocessor (e.g., to perform or control performance of one or more operations), a field-programmable gate array (FPGA), or an application-specific integrated circuit (ASIC).

The communication network 110 may include various communication media through which the system 102 may communicate with remote server 106 or other devices. Examples of the communication network 110 may include, but are not limited to, the Internet, a cloud network, a Wireless Fidelity (Wi-Fi) network, a Personal Area Network (PAN), a Local Area Network (LAN), a cellular network (such as, a Long-term evolution (or 4G) cellular network or a 5G cellular network), a satellite network (such as a network of low earth orbit satellites), and/or a Metropolitan Area Network (MAN)). Various devices in the environment 100 may connect to the communication network 110 using various wired and wireless communication protocols, including TCP/IP, UDP, HTTP, FTP, ZigBee, EDGE, IEEE 802.11, Li-Fi, IEEE 802.16, multi-hop communication, wireless access point (AP), device-to-device communication, cellular communication protocols, and Bluetooth.

The user device 112 may include logic, circuitry, and interfaces configured to display results including an anomaly score and time series data that corresponds to that anomaly score onto a graphical interface to the user 116. Examples of the user device 112 associated with the user 116 may include, but are not limited to, a smartphone, a tablet, a workstation, a wearable display, a portable computer, a light-based projection device, or any consumer electronic device with display feature.

During operation, the system 102 may receive the dataset 114 comprising time series data. For example, the dataset 114 may be received from at least one of the relational database 108, a user input, or a set of sensors. In an exemplary embodiment, the received time series data may be unlabeled data in a form of multivariate time series. The time series data of the dataset 114 may be a mix of anomalous data and non-anomalous data.

The system 102 may prepare, based on the dataset 114, a data input for the neural network 104. The data input may be prepared by performing data imputation on the time series data of the dataset 114. For example, the data imputation may be performed to fill missing values in the time series data (or raw time series data). After filling in the missing values, the data input may be obtained by creating windows of the time series data using a suitable window size. Further, by applying the encoder 104A to the data input, the system 102 may generate temporal embeddings and sample temporal correlation weights of the data input. The temporal embeddings may be representations of the data input in form of vectors in high-dimensional embedding space. Similar datapoints in the data input may have vectors that are closer to each other in the embedding space. In the context of multivariate time series, the temporal embeddings may be temporal graph embeddings which may capture interconnected variables over time. Each variable may be represented as a vector in the embedding space, where the distances between vectors reflect the similarities or dissimilarities between variables at different time points. Further, the sample temporal correlation weights may be the attention weights assigned to features of the time series data, during the training of the neural network 104. The sample temporal correlation weights may determine the strength of interaction or influence between time series data at different time points. For example, TransformerG2G model leverages transformers for temporal graph embeddings to determine temporal dependencies, influential dataset, and interactions within the temporal graph embeddings.

In another aspect, the system 102 may reconstruct anomalous time series data by applying the first decoder 104B to the temporal embeddings. The anomalous time series data may be reconstructed to generate the subtle anomalous data. As used herein, the subtle anomalous data may refer to a type of data sequence (or time series) that exhibits unusual or abnormal behavior, but in a subtle or less obvious manner. In time series analysis, anomalous patterns or outliers are data points that deviate significantly from the expected or normal behavior. However, subtle anomalies may be more challenging to detect because such anomalies may not exhibit extreme deviations or sudden changes. Instead, such anomalies may involve gradual shifts, small fluctuations, or irregular patterns that require careful analysis to identify.

Further, the system 102 may generate the first discriminator output by applying the second decoder 104C to the temporal embeddings. The discriminator output may be a result derived from the application of the discriminator network on the time series data. Similar to the output of the first decoder 104B, the first discriminator output may include a time series obtained after a reconstruction of the temporal embeddings.

The system 102 may feed the anomalous time series data (i.e., the reconstructed anomalous time series data) to the encoder 104A to output anomalous temporal embeddings and anomalous temporal correlation weights of the anomalous time series data. Further, the system 102 may generate a second discriminator output by applying the second decoder 104C to the anomalous temporal embeddings.

The system 102 may compute a divergence loss between the sample temporal correlation weights and the anomalous temporal correlation weights of the anomalous time series data. The divergence loss may be the KL divergence loss, for example. The divergence loss may be used to determine the temporal dynamics of nodes and edges associated with the graph embeddings over time. Further, the temporal dynamics of nodes and edges may be incorporated into node embeddings for prediction.

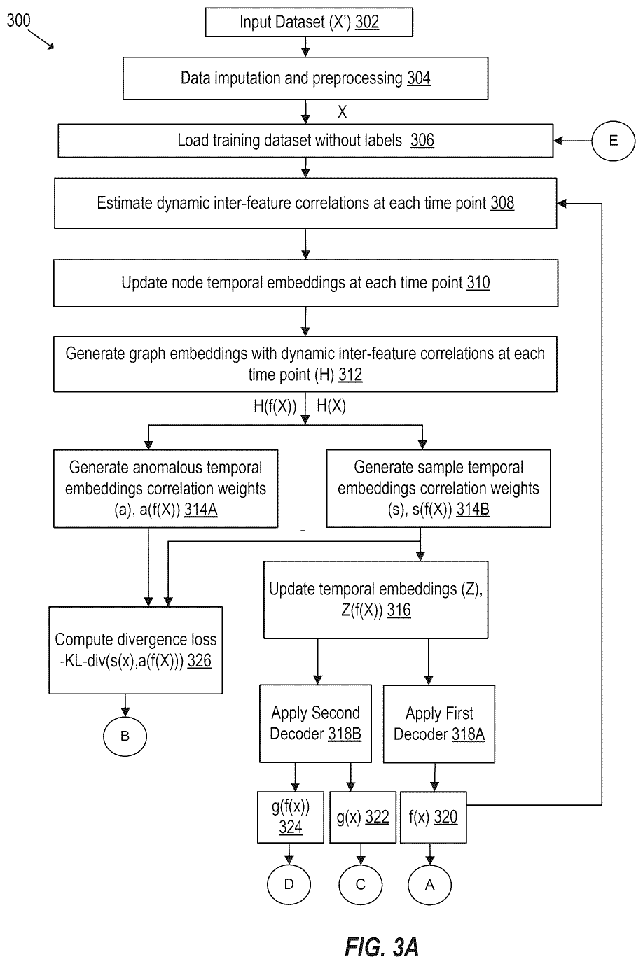

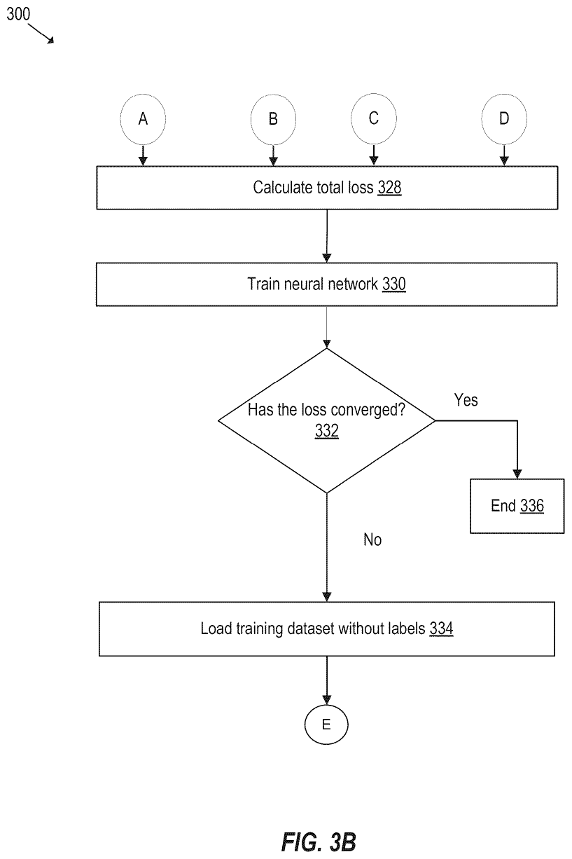

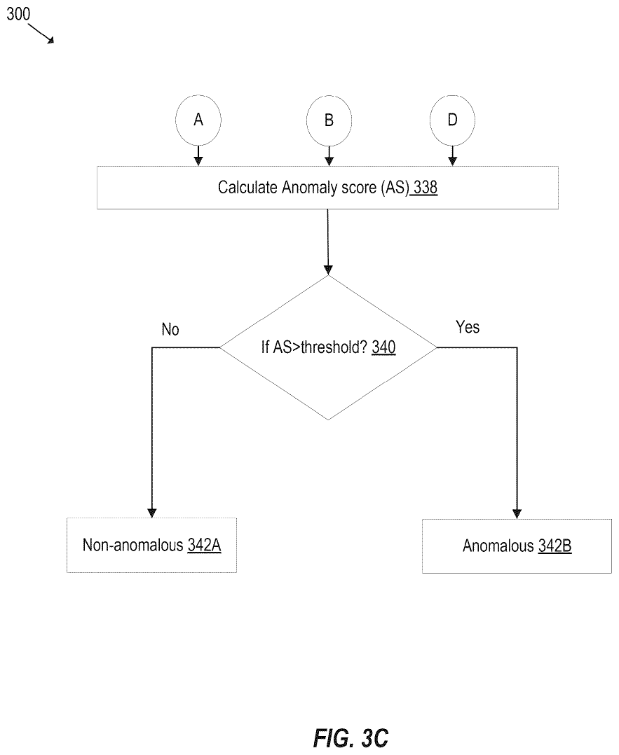

The system 102 may further compute reconstruction losses based on the data input, the anomalous time series data, the first discriminator output, and the second discriminator output. The reconstruction losses may be used to preserve the temporal proximity between nodes in windows of the data input. Further, the reconstruction losses may be used to learn meaningful representations by reconstructing the network structure or determine the temporal patterns. Further, the system 102 may train the neural network 104 based on the divergence loss and the reconstruction losses. Details related to the losses and training of the neural network 104 are provided in FIGS. 3A to 3C and FIG. 4, for example.

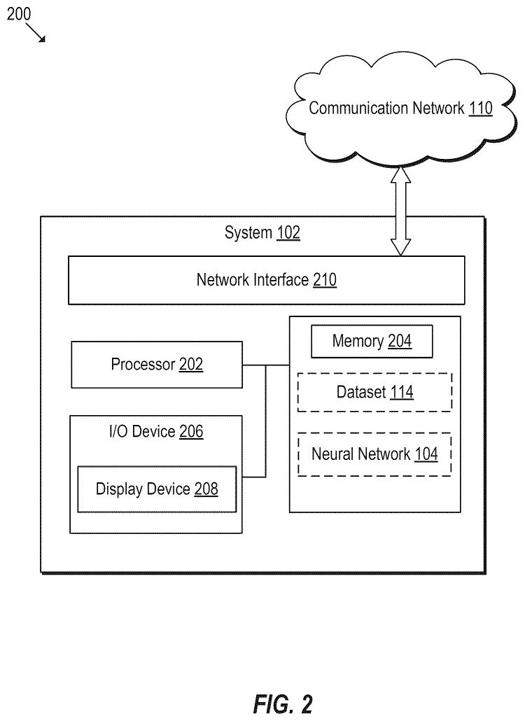

FIG. 2 is a block diagram that illustrates an exemplary system for time series anomaly detection using temporal correlation weights, arranged in accordance with at least one embodiment described in the present disclosure. FIG. 2 is explained in conjunction with elements from FIG. 1. With reference to FIG. 2, there is shown a block diagram 200 of the system 102. The system 102 may include a processor 202, a memory 204, an I/O device 206, and a network interface 210. The I/O device 206 may include a display device 208, for example. The memory 204 may store the dataset 114 and the neural network 104.

The processor 202 may include suitable logic, circuitry, and/or interfaces that may be configured to execute program instructions associated with different operations to be executed by the system 102. The processor 202 may include any suitable special-purpose or general-purpose computer, computing entity, or processing device, including various computer hardware or software modules, and may be configured to execute instructions stored on any applicable computer-readable storage media. For example, the processor 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, the processor 202 may include any number of processors configured to, individually or collectively, perform or direct performance of any number of operations of the system 102, as described in the present disclosure. Additionally, one or more of the processors may be present on one or more different systems, such as different remote servers.

In some embodiments, the processor 202 may be configured to interpret and/or execute program instructions and/or process data stored in the memory 204. After the program instructions are loaded into memory 204, the processor 202 may execute the program instructions. Some of the examples of the processor 202 may be a Graphical Processing Unit (GPU), a Central Processing Unit (CPU), a Reduced Instruction Set Computer (RISC) processor, an Application-Specific Integrated Circuit (ASIC) processor, a Complex Instruction Set Computer (CISC) processor, a co-processor, and/or a combination thereof.

The memory 204 may include suitable logic, circuitry, and/or interfaces that may be configured to store program instructions executable by the processor 202. In certain embodiments, the memory 204 may be configured to store information such as but not limited to the training data of time series data, anomaly score(s), and threshold anomaly score. The memory 204 may further store the neural network 104. In some respects, the neural network 104 may be placed out of the memory 204. The memory 204 may include computer-readable storage media for carrying or having computer-executable instructions or data structures stored thereon. Such computer-readable storage media may include any available media that may be accessed by a general-purpose or special-purpose computer, such as the processor 202.

Byway of example, and not limitation, such computer-readable storage media may include tangible or non-transitory computer-readable storage media, including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 202 to perform a certain operation or group of operations associated with the system 102.

The I/O device 206 may include suitable logic, circuitry, interfaces, and/or code that may be configured to receive a user input. The I/O device 206 may be further configured to provide an output in response to the user input. The I/O device 206 may include various input and output devices, which may be configured to communicate with the processor 202 and other components, such as the network interface 210. Examples of the input devices may include, but are not limited to, a touch screen, a keyboard, a mouse, a joystick, and/or a microphone. Examples of the output devices may include, but are not limited to, a display device 208 and a speaker. The I/O device 206 may be configured within the system 102 or outside of the system 102.

The network interface 210 may communicate with networks, such as the Internet, an Intranet, and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), light fidelity (Li-Fi), or Wi-MAX.

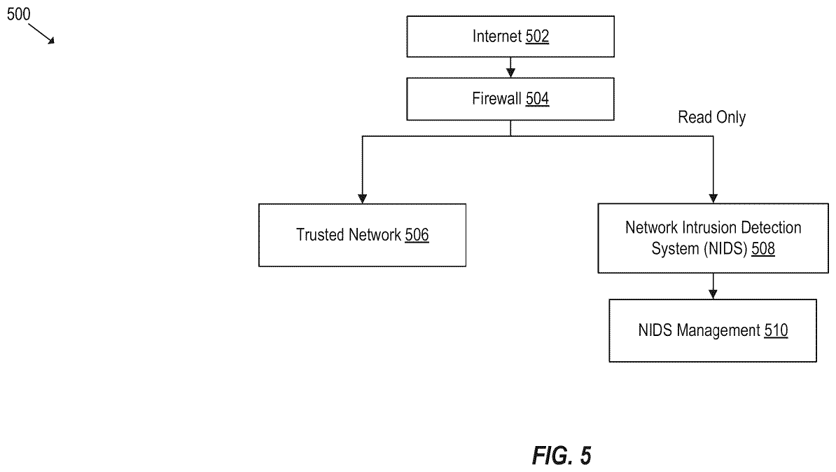

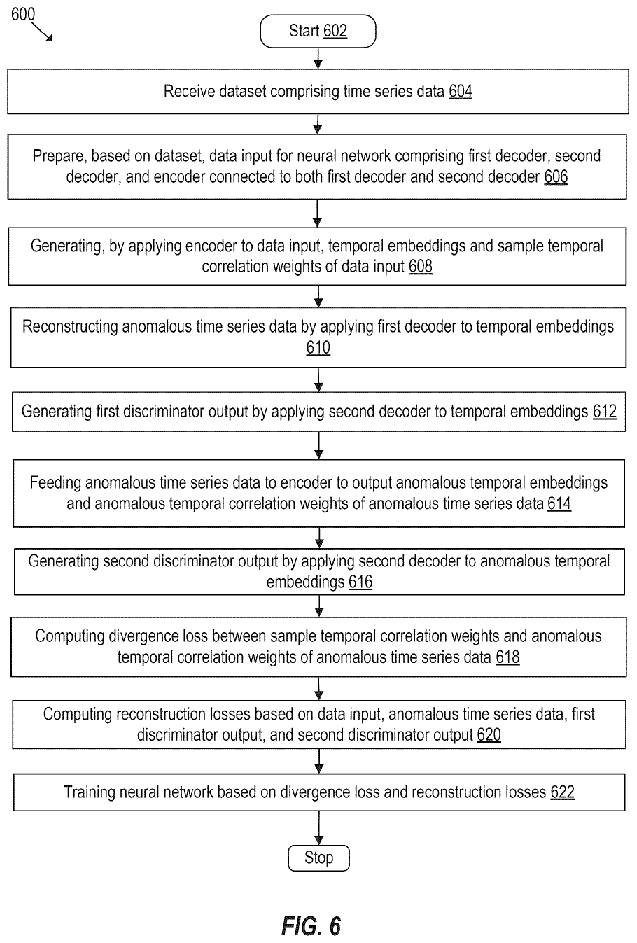

In certain embodiments, the system 102 may include the user device 112, the remote server 106 and the relational database 108. Modifications, additions, or omissions may be made to the system 102, without departing from the scope of the present disclosure. For example, in some embodiments, the system 102 may include any number of other components that may not be explicitly illustrated or described. The system 102, including the neural network 104, is described in detail in FIG. 3A, FIG. 3B, FIG. 3C, FIG. 4, FIG. 5, and FIG. 6.

FIGS. 3A to 3C are diagrams that collectively illustrate a flow chart of an example method for automated training and inference of time series anomaly detection using temporal correlation weights, in accordance with an embodiment of the disclosure. FIGS. 3A to 3C are described in conjunction with elements from FIG. 1 and FIG. 2. With reference to FIG. 3A to FIG. 3C, an execution flow 300 is shown. The exemplary execution flow 300 may include a set of operations that may be executed by one or more components of FIG. 1, such as the system 102. The operations may include dataset reception, data input preparation, temporal embeddings and sample temporal correlation weights generation, the anomalous time series data reconstruction, loss computation, and neural network training.

At 302, a dataset reception operation may be performed. The system 102 may be configured to receive a dataset (such as the dataset 114). The dataset 114 may include time series data such as network data. The dataset 114 may be received from at least one of the relational database 108, the user input, or a set of sensors in a network or IoT environment. In an example embodiment, the received time series data may be unlabeled data in a form of multivariate time series. For example, the multivariate time series data may be network traffic data that includes features such as number of active user equipment at downlink, number of packets for latency measurement at downlink, total user equipment scheduling time at downlink, and the like. An example of multivariate time series data (input data X) is provided as follows:

| | | | | | |
|---|---|---|---|---|---|
| 1:00 PM | 12 | 15 | 17 | 22 | 27 |
| 2:00 PM | 11 | 17 | 23 | 32 | 41 |
| 3:00 PM | 18 | 24 | 30 | 38 | 46 |
| 4:00 PM | 21 | 28 | 36 | 45 | 53 |
| 5:00 PM | 12 | 18 | 25 | 37 | 45 |

In certain instances, the time series data may be stored as a table in the relational database 108. In case of multivariate time series, each feature may correspond to a table column, and each table row may consist of feature values corresponding to a time instant.

At 304, a data input for the neural network 104 may be prepared. The preparation of the data input may include performing data imputation on the time series data to obtain refined time series data. The data imputation may include, for example addition of missing values in the time series data included in the received dataset 114. Further, the refined time series data may be divided into windows of the refined time series data. The data input may finally include the windows of the refined time series data.

At 306, a loading operation for training dataset may be performed. The data input in the form of windows of the refined time series data may be loaded in the memory 204 for training the neural network 104. Herein, the refined time series may be unlabeled in a form of multivariate time series and may include a mix of anomalous data and non-anomalous data.

At 308, an estimation of dynamic inter-feature correlations at each time point may be performed. The encoder 104A may be applied on the data input (i.e., windows of the refined time series data) to estimate the dynamic inter-feature correlations of the data inputs. The dynamic inter-feature correlations may refer to interdependencies and dynamic evolutionary patterns among variables or features of the time series data over time. Such correlations may be represented as connections between nodes in a graph, with each variable or feature represented as a node. Example methods that may be used for the estimation of such correlations may include, but are not limited to, graph convolutions, graph neural networks, or Eigen-entropy method.

At 310, an update operation on node temporal embeddings may be performed at each time point. Each feature of the time series data (or the data input) may be represented as a node (k) of a temporal graph (G). For each node (i), a corresponding node temporal embedding (Eᵢ^{k}) may be updated at each time point (tₖ) based on the estimated dynamic inter-feature correlations.

At 312, a generation of graph embeddings may be performed. Specifically, a graph embedding (H) may be generated (which incorporates dynamic inter-feature correlations) at each time point (tₖ) based on the updated node temporal embeddings at a corresponding time point. For example, for each time point (tₖ), the node temporal embeddings (Eᵢ) from the nodes (0, 1, . . . i) may be concatenated or averaged into the graph embedding (E_{G}).

At 314A, a generation of anomalous temporal correlation weights (a) may be performed. The anomalous temporal correlation weights (a) may be generated based on the graph embedding (H) at each time point and the attention layer (e.g., self-attention layer) of the encoder 104A. In comparison, conventional methods may use a gaussian kernel to estimate the anomalous data by assuming that the distribution of anomalous data follows gaussian distribution. In an example embodiment, the anomalous temporal correlation weights may be anomalous temporal graph correlation weights.

At 314B, a generation of sample temporal correlation weights (s or s(x)) may be performed at each time point. The sample temporal correlation weights (s(x)) may be generated based on the graph embeddings. In an example embodiment, the sample temporal correlation weights (s(x)) may be sample temporal graph correlation weights.

At 316, graph embeddings (H(x) or H) may be updated to generate temporal embeddings (Z(x) or Z). For instance, the encoder 104A may be applied on the graph embeddings (H(x)) to generate the temporal embeddings (Z(x)) as output of the encoder 104A. In an exemplary embodiment, the temporal embeddings (Z) may be global graph temporal embeddings that may be derived from the graph embeddings (H(x) or H).

At 318A, the first decoder 104B may be applied to the output of temporal embeddings, i.e., the generated output such as Z(X) to reconstruct the anomalous time series data (f(X)) (as a first reconstructed output. The anomalous time series data f(X) may be considered as generator output produced by the generator network, i.e., a combination of the encoder 104A and the first decoder 104B. In certain instances, the anomalous time series data (f(X)) may be referred to as subtle anomalous data. As used herein, the subtle anomalous data may refer to the type of data sequence (or time series) that exhibits unusual or abnormal behavior, but in a subtle or less obvious manner. An example of the anomalous time series data (f(X)) is provided as follows:

| | | | | | |
|---|---|---|---|---|---|
| 1:00 PM | 12 | 12 | 14 | 23 | 27 |
| 2:00 PM | 11 | 17 | 20 | 33 | 41 |
| 3:00 PM | 18 | 29 | 30 | 38 | 46 |
| 4:00 PM | 21 | 26 | 37 | 45 | 53 |
| 5:00 PM | 12 | 17 | 25 | 37 | 44 |

In this example, 23, 33, 29, 37, 37 at time 1:00 PM, 2:00 PM, 3:00 PM, 4:00 PM, 5:00 PM, respectively, may be subtle anomalies.

At 318B, the second decoder 104C may be applied to the output of temporal embeddings (Z(X)) to generate the first discriminator output. Thus, the second decoder 104C may decode the output such as Z(X) to generate the first discriminator output (denoted by g(X)) (as a second reconstructed output). The first discriminator output g(X) may be considered as the output generated by the discriminator network, i.e., a combination of the encoder 104A and the second decoder 104C.

At 320, the anomalous time series data (f(X)) may be fed back into an attention layer of the encoder 104A (at step 308 in FIG. 3A in a second pass. In the second pass, the graph embeddings with the dynamic inter-feature correlations H(f(X)) may be fed into the attention layer of the encoder 104A to generate the temporal embeddings Z(f(X)), the sample temporal correlation weights s(f(X)) and anomalous temporal correlation weights a(f(X)). It should be noted that the system 102 works in a loop with a number of passes and the anomalous time series data f(X) may be generated in a first pass.

At 322, an operation for the first discriminator output generation may be performed. The first discriminator output g(X) may be generated by applying the second decoder 104C to the temporal embeddings (Z(X)).

In a second pass, steps from 308 to 316 may be performed again with f(X) as input to the encoder 104A. The steps from 308 to 316 in the second pass may generate graph embeddings with dynamic inter-feature correlations H(f(X)), sample temporal graph correlation weights s(f(X)), anomalous temporal correlation weights a(f(X)), and output of graph temporal embeddings, i.e., the generated output Z(f(X)).

At 324, an operation for the second discriminator output generation may be performed. The second discriminator output may be generated by applying the second decoder 104C to the anomalous temporal embeddings (Z(f(X)) obtained in the second pass). In an embodiment, the anomalous temporal embeddings may be the anomalous graph temporal embeddings. Herein, the second decoder 104C may decode the output such as Z(f(X)) to generate the second discriminator output (denoted by g(f(X))) as a third reconstructed output.

At 326, an operation of divergence loss computation may be performed. The divergence loss may be calculated between the sample temporal correlation weights and the anomalous temporal correlation weights of the anomalous time series data. For instance, the divergence loss may be the Kullback-Leibler divergence loss (KL-div(s(X), a(f(X))). Here, the sample temporal graph correlation weights s(X) may be generated in the first pass and the anomalous temporal graph correlation weights a(f(X)) may be generated in the second pass by the system 102.

The KL divergence loss may be computed to increase the differentiability between the non-anomalous data and the anomalous/subtle anomalous data. Further, the computation of divergence loss may be based on self-attention mechanism of the encoder 104A for both the anomalous temporal graph correlation weights a(f(X)) and the sample temporal graph correlation weights s(X). The KL divergence may represent the information gain between the two weight distributions (s(X) and a(f(X))). A symmetrical KL-divergence may address the asymmetry of traditional KL-divergence by taking the average of the divergence in both directions, making balanced measure of the difference between the two weight distributions (s(X) and a(f(X))). The KL-div loss may be obtained by averaging KL divergence values obtained from various layers of the neural network 104, as provided in equation (1), as follows:

$$KL - div = [ \frac{1}{L} {\sum }_{l = 1}^{L} ( {KL ( af ( x ) )}_{i , :}^{l} ∥ {s ( x )}_{i , :}^{l} ) + {KL ( {s ( x )}_{i , :}^{l} ∥ af ( x ) )}_{i , :}^{l} ) ) ] \qquad ( 1 )$$

where, KL−divϵR^{k×1},
k is the number of time points, and
KL(⋅∥⋅) denotes the KL divergence calculated between two discrete distributions associated with each row of a(f(X))^{l} and s(X)^{l}.
l is the minimum limit applied on function; and
i is the number of passes.

Referring to FIG. 3B, a flowchart with operations from 328 to 334 for the training of the neural network 104 is shown.

At 328, a calculation for total loss (for example, total loss 414 in FIG. 4) may be performed. The total loss may be the sum of total reconstruction losses and total divergence loss. The total loss may be obtained using equation (2), as follows:

Total Loss (T_{L})=Total reconstruction loss (T_{RL})+Total divergence loss (T_{DL}) (2)

The total divergence loss (L4) may be computed based on KL divergence loss. Further, the KL divergence loss may be computed between the temporal correlation weights of input data and temporal correlation weights of anomalous time series data. The computation may be based on pass index (of the number of passes) and a weighting factor. As an example, the total divergence loss may be calculated based on following equation (3):

$${T}_{DL} = L 4 = γ ( 1 - \frac{1}{r} ) {‖ KL - div ( ( s ( x ) ) and a ( f ( x ) ) ) ‖}_{1} \qquad ( 3 )$$

where, r represents the current index of pass of the number of passes. For example, during the first pass r=1, and during the second pass r=2, and so on;
γ parameter serves as the weighting factor that may balance the contributions of different loss terms.

The reconstruction losses may be calculated based on the data input, the anomalous time series data f(X), the first discriminator output g(x), and the second discriminator output g(f(x)). The reconstruction losses may include a generator reconstruction loss (L1), a first discriminator reconstruction loss (L2), and a second discriminator reconstruction loss (L3). The generator reconstruction loss (L1) may be calculated between the data input and the anomalous time series data. Similarly, the first discriminator reconstruction loss (L2) may be calculated between the data input and the first discriminator output, and the second discriminator reconstruction loss (L3) may be calculated between the data input and the second discriminator output.

In an embodiment, the total loss may be the sum of a total generator loss and a total discriminator loss. The total generator loss (L_{ED1}) may be calculated as a weighted sum of the divergence loss (L4), the generator reconstruction loss (L1), and the second discriminator reconstruction loss (L3), as given by following equation (4):

$${L}_{E D 1} = L 4 + L 1 + L 3 \qquad ( 4 )$$

where L1 is reconstruction loss of generator=(∥X−f(X)∥₂);
L3 is reconstruction loss of second discriminator=(∥X−g(f(X))∥₂); and
L4 is KL divergence loss ([temporal correlation weights of input data]_{detach} and temporal correlation weights of anomalous time series data)
Herein, detach refers to the duration when the backpropagation of the weights is detached and not updated.

In an embodiment, the total generator loss L_{ED1} may be minimized and gradient may be backpropagated. For instance, L1 may be minimized to update the weights of the first decoder 104B, the graph temporal embedding block (such as block “a” 408A of the encoder 104A), sample temporal graph correlation weights block (such as block “b” 408B of the encoder 104A), and the dynamic graph embeddings generator (such as dynamic graph embeddings generator 406A) of the encoder 104A. L3 may be minimized to update weights of the first decoder 104B, the graph temporal embedding block (such as block “a” 408A of the encoder 104A), sample temporal graph correlation weights block (such as block “b” 408B of the encoder 104A), and the dynamic graph embeddings generator (such as the dynamic graph embeddings generator 406A) of the encoder 104A. Further, L4 may be minimized to update the weights of anomalous temporal graph correlation weights block (such as block “c” 408C of the encoder 104A).

Further, the total discriminator loss (L_{ED2}) may be calculated as a weighted sum of the first discriminator reconstruction loss (L2) and a negative weighted sum of the divergence loss (L4) and the second discriminator reconstruction loss (L3), as given by following equation (5):

$${L}_{E D 2} = L 2 - L 3 - L 4 \qquad ( 5 )$$

where L2 is Reconstruction loss of first discriminator=(∥x−g(x)∥₂).
L3 is Reconstruction loss of second discriminator=(∥x−g(f(X))∥₂); and
L4 is KL divergence loss ([temporal correlation weights of input data]_{detach} and temporal correlation weights of anomalous time series data)

In an embodiment, the total discriminator loss L_{ED2} may be minimized and gradient may be backpropagated as follows. L2 may be minimized to update the weights of the second decoder 104C, the graph temporal embedding block (such as block “a” 408A of the encoder 104A), sample temporal graph correlation weights block (such as block “b” 408B of the encoder 104A), and the dynamic graph embeddings generator of the encoder 104A. L3 may be maximized to update weights of the second decoder 104C, the graph temporal embedding block (such as block “a” 408A of the encoder 104A), sample temporal graph correlation weights block (such as block “b” 408B of the encoder 104A), and the dynamic graph embeddings generator of the encoder 104A. L4 may be maximized to update the weights of sample temporal graph correlation weights block (such as block “b” 408B of the encoder 104A).

At step 330, the neural network 104 may be trained using the total loss. The training may be performed to minimize the total reconstruction loss (T_{RL}) of data input, maximize the reconstruction of the anomalous time series data f(X), and increase the divergence between the anomalous data and the non-anomalous data (differentiable criteria) that increases the differentiability between the subtle anomalous and the non-anomalous data samples. Further, the neural network 104 may be trained based on the divergence loss and the reconstruction losses that may be calculated during the calculation of total loss (414 in FIG. 4).

In an embodiment, the neural network 104 may be trained by selectively updating the temporal embedding block (for example, block “a” 408A in FIG. 4), the temporal correlation weights block (for example, block “b” 408B in FIG. 4), or the anomalous temporal correlation weights block (for example, block “c” 408C in FIG. 4) weights inside the encoder 104A during backpropagation. Thus, the discriminator may be trained to discriminate between the subtle anomalies and the non-anomalous data with high margin by increasing the difference between temporal embeddings.

In an embodiment, the training of neural network 104 may include updating weight parameters of the first decoder 104B, the graph embedding generation block (for example, dynamic graph embedding generator 406A in FIG. 4), the temporal embedding block (for example, block “a” 408A in FIG. 4), and the temporal correlation weights block (for example, block “b” 408B in FIG. 4) by minimizing the total generator loss including the generator reconstruction loss and the second discriminator reconstruction loss and updating weight parameters of the anomalous temporal correlation weights block (for example, block “c” 408C in FIG. 4) by minimizing the divergence loss. In another embodiment, the training of neural network 104 may include updating weight parameters of the second decoder 104C, the graph embedding generation block (for example, dynamic graph embedding generator 406A in FIG. 4), the temporal embedding block (for example, block “a” 408A in FIG. 4), and the temporal correlation weights block (for example, block “b” 408B in FIG. 4) by minimizing the total discriminator loss and maximizing the second discriminator reconstruction loss. Further, the training of neural network 104 may include updating weight parameters of the anomalous temporal correlation weights block (for example, block “c” 408C in FIG. 4) by maximizing the divergence loss.

At 332, an operation for loss convergence check may be performed. The convergence loss may be checked as part of a stopping criteria to finish the training of neural network 104. The neural network 104 may be considered to have converged when the training loss (or total loss) stops decreasing or has reached a minimum level of acceptable error. The minimum level may be achieved by adjusting the weights over a number of epochs of the training of the neural network 104.

At 332, If the loss for the neural network 104 does not converge, the system 102 may pass control to step 334 and continue training the neural network 104.

At 332, if the loss for the neural network 104 converges, the system 102 may pass the control to the step 336 and the training of neural network 104 may end. After the training ends, the neural network 104 may be considered to be trained. Once the neural network 104 is trained, the anomalous data or non-anomalous data may be determined in a test phase by running procedure of anomaly score calculation and comparison, as described herein.

Referring to FIG. 3C, a flowchart 338-342 shows the test phase of the trained neural network 104.

At 338, an operation for an anomaly score calculation may be performed. The anomaly score may be calculated based on the divergence loss L4 (i.e., B from 326 in FIG. 3A), the data input X (prepared based on dataset 114), the anomalous time series data f(X) (i.e., A from 320 in FIG. 3A), and the second discriminator output g(f(X)) (i.e., D from 324 in FIG. 3A). The system 102 may acquire input time series data from a user device (for example, the user device 112) and feed the input time series data to the trained neural network 104 to compute an anomaly score of the input time series data.

At 340, an operation for comparison of the anomaly score may be performed. The anomaly score of the input time series data may be compared with a threshold score. The threshold score may be a predefined number associated with the required result. The required result may further be associated with the loss being covered.

At 342, an operation for a class determination may be performed. The comparison of the anomaly score of the neural network 104 and the threshold score may determine the class of the input time series data. The class of the input time series data may be one of anomalous data (such as, an anomalous data obtained at step 342B of FIG. 3C) or non-anomalous data (such as non-anomalous data obtained at step 342A of FIG. 3C). Further, the system 102 may control the user device to display a result including the anomaly score and the class (anomalous data or non-anomalous data).

FIG. 4 is a diagram that illustrates an exemplary architectural diagram of the system for time series anomaly detection using temporal correlation weights, in accordance with an embodiment of the disclosure. FIG. 4 is described in conjunction with elements from FIG. 1, FIG. 2, FIG. 3A, FIG. 3B, and FIG. 3C. The exemplary architecture of the system 102 shows the anomaly detection illustrated in the exemplary environment 400 may be implemented by any suitable system, apparatus, or device, such as the example system 102 of FIG. 1 or processor 202 of FIG. 2.

The system 102 may receive a dataset comprising time series data (X′) at 402. The system 102 at 404 may process the dataset to prepare a data input X for the neural network 104. As shown, the neural network 104 comprises the first decoder 104B, the second decoder 104C, and the encoder 104A connected to both the first decoder 104B and the second decoder 104C. The encoder 104A may include dynamic graph embeddings generator 406A, a block “a” 408A, a block “b” 408B, and a block “c” 408C. The block “a” 408A may be the temporal embedding block, the block “b” 408B may be the temporal correlation weights block, and the block “c” 408C may be anomalous temporal correlation weights block.

The system 102 in the first pass may generate, by applying the encoder 104A to the data input X, the temporal embeddings Z(X) and the sample temporal correlation weights s(X) of the data input (X). The temporal embeddings Z(X) may be generated by the temporal embedding block 408A, and the sample temporal correlation weights s(X) may be generated by the temporal correlation weights block 408B. Details related to generation of Z(X), s(X), and f(X) are described in the FIG. 3A.

The system 102 in the second pass may generate, by applying the encoder 104A to the anomalous time series data f(X), the temporal embeddings Z(f(X)), the anomalous temporal correlation weights (a(f(X)), and the sample temporal correlation weights s(f(X)) of the anomalous time series data f(X). The temporal embeddings Z(f(X)) may be generated by the temporal embedding block 408A, and the sample temporal correlation weights s(f(X)) may be generated by the temporal correlation weights block 408B. Furthermore, the anomalous temporal correlation weights a(f(X)) may be generated by the anomalous temporal correlation weights block 408C using the sample temporal correlation weights (s(f(X))). Details related to generation of Z(f(X)), s(f(X)), and a(f(X)) are described in FIGS. 3A, 3B, and 3C.

The system 102 may reconstruct the anomalous time series data f(X) in the first pass by applying the first decoder 104B to the temporal embeddings Z(X). Further, the system 102 may generate the first discriminator output g(x) by applying the second decoder 104C to the temporal embeddings Z(X). Further, the system 102 may feed the anomalous time series data f(X) to the encoder 104A to generate the output anomalous temporal embeddings Z(f(X)) in the second pass, and the anomalous temporal correlation weights a(f(X)) of the anomalous time series data f(X) in the second pass. Furthermore, the system 102 may generate the second discriminator output g(f(X)) by applying the second decoder 104C to the anomalous temporal embeddings Z(f(X)) in the second pass.

In an embodiment, the system 102 may compute the divergence loss (L4 410D) between the sample temporal correlation weights s(X) (i.e., generated in the first pass) and the anomalous temporal correlation weights a(f(X)) (i.e., generated in the second pass) of the anomalous time series data f(X).

In an embodiment, the system 102 may compute reconstruction losses based on the data input (X), the anomalous time series data f(X), the first discriminator output (g(X)) (i.e., generated in the first pass), and the second discriminator output g(f(X)) (i.e., generated in the second pass) and train the neural network 104 based on the divergence loss L4 410D and the reconstruction losses.

In an embodiment, the reconstruction losses may be calculated based on the data input, the anomalous time series data, the first discriminator output g(x) (i.e., generated in the first pass), and the second discriminator output g(f(X)) (i.e., generated in the second pass). The reconstruction losses may include the generator reconstruction loss L1 410A, the first discriminator reconstruction loss L2 410B, and the second discriminator reconstruction loss L3 410C. The generator reconstruction loss L1 may be calculated as L2-norm between the data input (X) and the anomalous time series data f(X) (i.e., generated in the second pass). Similarly, the first discriminator reconstruction loss L2 may be calculated as L2-norm between the data input (X) and the first discriminator output g(X) (i.e., generated in the first pass). The second discriminator reconstruction loss L3 may be calculated as L2-norm between the data input X and the second discriminator output g(f(X)) (i.e., generated in the second pass).

In an embodiment, the total loss T_{L} 414 may be the sum of the total generator loss (L_{ED1} 412A) and the total discriminator loss (L_{ED2} 412B). The total generator loss T_{L} 414 may calculated as a weighted sum of the divergence loss L4 410D, the generator reconstruction loss L1 410A, and the second discriminator reconstruction loss L3 410C. Herein, L1 is Reconstruction loss of generator (∥X−f(X)∥₂), L2 is Reconstruction loss of first discriminator (∥X−g(X)∥₂), L3 is Reconstruction loss of second discriminator (∥X−g(f(X))∥₂), and L4 is KL divergence loss ([s(X)]_{detach} and a(f(X))). Details related to calculation of L1, L2, L3 and L4 are described in the FIGS. 3A, 3B, and 3C.

In an embodiment, the total generator loss L_{ED1} 412A may be minimized and gradient may be backpropagated as the L1 410A may be minimized to update the weights of the first decoder 104B, the temporal embedding block (for example, block “a” 408A in FIG. 4), temporal correlation weights block (for example, block “b” 408B in FIG. 4), the graph embeddings with the dynamic inter-feature correlations block (for example, dynamic graph embeddings generator 406A), and the L3 410C may be minimized to update weights of the first decoder 104B, the graph temporal embeddings for example, block “a” 408A in FIG. 4), the temporal graph correlation weights (for example, block “b” 408B in FIG. 4), the graph embeddings with the dynamic inter-feature correlations block (for example, dynamic graph embeddings generator 406A) and the L4 410D may be minimized to update the weights of the anomalous temporal graph correlation weights block (for example, block “c” 408C in FIG. 4). Further, the total discriminator loss L_{ED2} 412B may be calculated as the weighted sum of the first discriminator reconstruction loss L2 410B and the negative weighted sum of the divergence loss L4 410D and the second discriminator reconstruction loss L3 410C.

In an embodiment, the total discriminator loss L_{ED2} 412B may be minimized and gradient may be backpropagated while L2 410B is minimized to update the weights of the second decoder 104C, the block “a” 408A of the encoder 104A, the block “b” 408B of the encoder 104A, and the dynamic graph embeddings generator 406A of the encoder 104A. L3 410C may be maximized to update weights of the second decoder 104C, the block “a” 408A of the encoder 104A, the block “b” 408B of the encoder 104A, and the dynamic graph embeddings generator 406A of the encoder 104A. L4 410D may be maximized to update the weights of the block “b” 408B of the encoder 104A.

In an embodiment, the neural network 104 may include two virtual autoencoders. The first virtual autoencoder may be labeled as ED1 and the second autoencoder may be labeled as ED2. The two virtual autoencoders may share a common encoder 104A. Furthermore, the first decoder 104B may be represented as D1 that may correspond to ED1 (virtual autoencoder) and the second decoder 104C may be represented as D2 that may correspond to ED2 (virtual autoencoder). The output of the encoder 104A in the first pass may be represented as Z and the reconstructed output of the ED1 may be denoted as f(X) and the reconstructive output of the ED2 may be denoted as g(X). Thus, the output equation may be given by following equations (6) and (7), as follows:

$$f ( X ) = Z \cdot {W}_{D 1} \qquad ( 6 )$$

$$g ( X ) = Z \cdot {W}_{D 2} \qquad ( 7 )$$

where, W_{D1} is the weighted matrix of the first decoder 104B (D1); and
the W_{D2} is the weighted matrix of the second decoder 104C (D2).

In an embodiment, the output of the encoder 104A in the second pass may be represented as Z(X) and the reconstructive output of the ED2 may be denoted as g(f(X)).

In an embodiment, both virtual autoencoders (ED1 and ED2) may be trained to accurately reconstruct the input data X (prepared based on received dataset 114) by minimizing the reconstruction loss of ED1 (minED1 ∥x−f(X)∥₂) and minimizing the reconstruction loss of ED2 (minED2 ∥x−g(X)∥₂) during the first pass of the number of passes. Further, the weights assigned to LED1 and LED2 may be high during the first pass of the number of passes. Further, as the pass progresses, the neural network 104 may be trained based on the divergence loss L4 410D. Further, the neural network 104 may be trained so that the second autoencoder ED2 distinguishes between input data (X) and reconstructed output (such as, the generator output f(X) (i.e. generated in the first pass), the first discriminator output g(x) (i.e. generated in the first pass), or the second discriminator output g(f(X)) (i.e. generated in the second pass). Further, the neural network 104 may be trained so that the first virtual autoencoder ED1 deceives the second virtual autoencoder ED2. In other words, the first virtual autoencoder ED1 may minimize the difference between input data X and the second discriminator output g(f(X)) (minED1|X−g(f(X))|₂) and the second virtual autoencoder ED2 may maximize the difference (maxED2|X−g(f(X))|₂). Furthermore, the neural network 104 may be trained to enhance the differentiability between the non-anomalous data and the anomalous temporal embeddings, which may be achieved by the divergence loss L4 410D. The first virtual autoencoder ED1 may minimize the L4 410D, and the second virtual autoencoder ED2 may maximize the L4 410D. During the minimization of divergence loss L4 410D in the first virtual encoder LED1, the gradient backpropagation may be stopped in the temporal correlation weights block 408B. Further, during maximization of divergence loss L4 410D in the second virtual autoencoder LED2, the gradient backpropagation may be stopped in the anomalous temporal correlation weights block 408C. By applying a minimax strategy between the temporal correlation weights (s(X)) of block “b” 408B and the anomalous temporal correlation weights a(f(X)) of block “c” 408C, the system 102 may increase the distinction between the non-anomalous data and the anomalous data.

The training objective for ED1 and ED2 may be defined as follows equations (8 and 9):

$${L}_{ED 1} = \frac{1}{r} {‖ X - f ( X ) ‖}_{2} + ( 1 - \frac{1}{r} ) ( {‖ X - g ( f ( X ) ) ‖}_{2} + γ ( 1 - \frac{1}{r} ) {‖ KL - div ‖}_{1} ) \qquad ( 8 )$$

$${L}_{ED 2} = \frac{1}{r} {‖ X - g ( X ) ‖}_{2} + ( 1 - \frac{1}{r} ) ( {‖ X - g ( f ( X ) ) ‖}_{2} + γ ( 1 - \frac{1}{r} ) {‖ KL - div ‖}_{1} ) \qquad ( 9 )$$

where, r represents the current index of pass of the number of passes. For example, during the first pass r=1, and during the second pass r=2, and so on;
γ parameter serves as a weighting factor that may balance the contributions of different loss terms.

In an embodiment, early stopping criterion may be used during the training of the neural network 104. Specifically, the training may be stopped when the value of the L_{ED1} stops declining for two consecutive passes. During the detection of anomalous data, the anomaly score (ASϵR^{k×1}) may be defined as following equation (10):

$${AS}_{i} = π ( - KL - div ) ( {‖ Xi - {f ( X )}_{i} ‖}_{2} + {‖ {X}_{i} - {g ( f ( X ) )}_{i} ‖}_{2} ) \qquad ( 10 )$$

where π is the SoftMax function; and
⊚ is the elementwise multiplication.

In an embodiment, the threshold may be set by using the qₜₕ percentile (threshold=Percentile(AS, q)), i.e., instances may be labeled as anomalies if the scores are higher than the qₜₕ percentile within the anomaly score distribution.

FIG. 5 is a diagram that illustrates an exemplary Network-based Intrusion Detection System (NIDS), in accordance with an embodiment of the disclosure. FIG. 5 is described in conjunction with elements from FIG. 1, FIG. 2, FIG. 3A, FIG. 3B, and FIG. 4. With reference to FIG. 5, there is shown the exemplary environment 500. The method illustrated using the exemplary environment 500 may be performed by any suitable system, apparatus, or device, such as, by the example system 102 of FIG. 1, or processor 202 of FIG. 2.

The NIDS 508 may be connected to a firewall 504 in read only mode. The firewall may further be connected to a trusted network 506 and may be wirelessly or wired connected with an internet 502. Further, the NIDS 508 may be connected to a NIDS management 510.

The NIDS 508 may monitor network traffic for potential threats without disrupting the network. The NIDS 508 may operate in read only mode to analyze all types of traffic, including unicast traffic. The NIDS 508 may be positioned at the internal interface of the firewall 504. The firewall 504 may observe traffic in read-only mode and send alerts to the NIDS management server through any different network interface.

In an embodiment, the NIDS 508 may monitor and analyze the network traffic based on the trained neural network 104. The outputs (as described in FIGS. 3A to 3C and FIG. 4) from the trained neural network 104 may be used to compute the anomaly score of the input data (time series of the network traffic) and determine the class of the input data as one of anomalous or non-anomalous. Based on the class of input data, the NIDS 508 may determine the potential or ongoing attacks on the network such as internet 502. In an exemplarily embodiment, the NIDS 508 may be a security technology that may monitor and analyze network traffic for signs of malicious activity, unauthorized access, or security policy violations. The primary function of the NIDS 508 may be to detect and alert network administrators of any potential or ongoing attacks on the network such as internet 502. The NIDS 508 may examine data packets for specific patterns and behaviors that may indicate the presence of an attack. The NIDS 508 may be an essential component of a comprehensive network security strategy. Alternatively, the NIDS 508 may use the trained neural network 104 of the system 102 for examining the incoming data packets for specific patterns and behaviors that may indicate the presence of an attack. Further, the specific patterns may be detected by the trained neural network 104 of the system 102 as anomalous data.

FIG. 6 is a diagram that illustrates a flowchart of an example for time series anomaly detection using temporal correlation weights, in accordance with an embodiment of the disclosure. FIG. 6 is described in conjunction with elements from FIG. 1, FIG. 2, FIG. 3A, FIG. 3B, FIG. 3C, FIG. 4 and FIG. 5. With reference to FIG. 6, there is shown the exemplary flow 600. The method illustrated in the exemplary flow 600 may be performed by any suitable system, apparatus, or device, such as, by the example system 102 of FIG. 1, or processor 202 of FIG. 2. Although illustrated with discrete blocks, the steps and operations associated with one or more of the blocks of the flow 600 may be divided into additional blocks, combined into fewer blocks, or eliminated, depending on the particular implementation. The operations may start at 602 and may proceed to 622.

At 604, dataset 114 comprising time series data may be received by the system 102. The time series data may be unlabeled data in a form of multivariate time series. The time series data of the dataset 114 may be a subtle anomalous data or may be a mix of anomalous data and non-anomalous data.

At 606, a data input (for example, X in FIG. 4) for the neural network 104 may be prepared based on the dataset. The neural network 104 may comprise the first decoder 104B, the second decoder 104C, and the encoder 104A connected to both the first decoder 104B and the second decoder 104C. The processor 202 may perform data imputation on the time series data of the dataset 114 to obtain refined time series data (X) and divide the refined time series data into windows of the refined time series data. Further the data input includes the windows of the refined time series data. The encoder 104A may include the dynamic graph embeddings generator 406A, the temporal embedding block 408A, the temporal correlation weights block 408B, and the anomalous temporal correlation weights block. The encoder 104A and the first decoder 104B together form the generator network, and alternatively, the encoder 104A and the second decoder 104C together form the discriminator network.

At 608, temporal embeddings and sample temporal correlation weights (for example, s(X), s(f(X)) in FIG. 4) may be generated by applying the encoder 104A to of the data input (X). The application of the encoder 104A includes generating graph embeddings (For example, Z(X) or Z(f(X)) in FIG. 4) with dynamic inter-feature correlations (for example, H(X) or H(f(X)) in FIG. 4) based on the data input (X) and feeding the graph embeddings with the dynamic inter-feature correlations (H(X) in first pass or H(f(X)) in second pass) into an attention layer of the encoder 104A to generate the temporal embeddings and the sample temporal correlation weights. The temporal embeddings may be the graph temporal embeddings (Z(X) in first pass or Z(f(X)) in second pass), the sample temporal correlation weights may be sample temporal graph correlation weights (s(X) in first pass or s(f(X)) in second pass), and the attention layer may be the self-attention mechanism. Further, the anomalous temporal embeddings may be the anomalous graph temporal embeddings and the anomalous temporal correlation weights may be the anomalous temporal graph correlation weights (for example, a(X) in first pass or a(f(X)) in second pass in FIG. 4).

In an embodiment, the encoder 104A includes the dynamic graph embeddings generator 406A, the temporal embedding block “a” 408A, a temporal correlation weights block “b” 408B, and an anomalous temporal correlation weight block “c” 408C.

At 610, the anomalous time series data (For example, f(X) in FIG. 4) may be reconstructed by applying the first decoder 104B to the temporal embeddings. Further, the encoder 104A and the first decoder 104B together form the generator network.

At 612, the first discriminator output (For example, g(X) in FIG. 4) may be generated by applying the second decoder 104C to the temporal embeddings. Further, the encoder 104A and the second decoder 104C together form the discriminator network.

At 614, the anomalous time series data f(X) may be fed to the encoder 104A to output anomalous temporal embeddings and anomalous temporal correlation weights of the anomalous time series data.

At 616, the second discriminator output (For example, g(f(X)) in FIG. 4) may be generated by applying the second decoder 104C to the anomalous temporal embeddings. Further, the encoder 104A and the second decoder 104C together form the discriminator network.

At 618, the divergence loss (For example, L4 410D at FIG. 4) between the sample temporal correlation weights and the anomalous temporal correlation weights of the anomalous time series data f(X) may be computed. The divergence loss (L4 410D) may be the KL divergence loss.

At 620, reconstruction losses may be computed based on the data input (X), the anomalous time series data f(X), the first discriminator output g(X), and the second discriminator output g(f(X)). The reconstruction losses include the generator reconstruction loss (For example, L1 410A in FIG. 4), the first discriminator reconstruction loss (For example, L2 410B in FIG. 4), and the second discriminator reconstruction loss (For example, L3 410C in FIG. 4). The generator reconstruction loss (L1 410A) may be between the data input (X) and the anomalous time series data f(X). The first discriminator reconstruction loss may be between the data input (X) and the first discriminator output (g(X)). The second discriminator reconstruction loss may be between the data input (X, or f(X)) and the second discriminator output g(f(X)).

In an embodiment, the processor 202 may be configured to calculate a total generator loss (For example, LED1 in FIG. 4) as a weighted sum of the divergence loss L4 410D, the generator reconstruction loss L1 410A, and the second discriminator reconstruction loss L3 410C. Further, the processor 202 may be configured to calculate a total discriminator loss (For example, LED2 in FIG. 4) as a weighted sum of the first discriminator reconstruction loss L2 410B and a negative weighted sum of the divergence loss L4 410D and the second discriminator reconstruction loss L3 410C. The neural network 104 may be trained based on the total generator loss LED1 and the total discriminator loss LED2. The total generator loss LED1 and the total discriminator loss LED2 may be represented as following equations (11) and (12):

$$LED 1 = L 1 + L 3 + L 4 ; \qquad ( 11 )$$

$$LED 2 = L 2 - L 3 - L 4 ; \qquad ( 12 )$$

At 622, the neural network 104 may be trained based on the divergence loss (L4 410D) and the reconstruction losses. The training of the neural network 104 may include updating weight parameters of the first decoder 104B, the dynamic graph embeddings generator 406A, the temporal embedding block 408A, and the temporal correlation weights block 408B by minimizing the total generator loss (for example, LED1 in FIG. 4) including the generator reconstruction loss L1 410A and the second discriminator reconstruction loss L3 410C and updating weight parameters of the anomalous temporal correlation weights block by minimizing the divergence loss L4 410D. Further, the training of the neural network 104 may include updating weight parameters of the second decoder 104C, the dynamic graph embeddings generator 406A, the temporal embedding block 408A, and the temporal correlation weights block 408B by minimizing the total discriminator loss (For example, LED2 in FIG. 4) and maximizing the second discriminator reconstruction loss L3 410C and updating weight parameters of the anomalous temporal correlation weights block by maximizing the divergence loss L4 410D.

In an embodiment, the processor 202 may be configured to compute the anomaly score (in FIG. 3C) based on the divergence loss L4 410D (in FIG. 4), the data input (X), the anomalous time series data f(X), and the second discriminator output (g(f(X)). Further, the processor 202 may be configured to acquire input time series data (dataset 114 (X′)) from the user device 112 and feeds the input time series data (X′) to the trained neural network 104 to compute the anomaly score of the input time series data (X′). Further, the processor 202 may be configured to compare the anomaly score of the input time series data (X′) with a threshold score and determine a class of the of the input time series data as one of anomalous data or non-anomalous data based on the comparison. Furthermore, the processor 202 may be configured to control the user device 112 to display a result including the anomaly score and the class.

It should be noted that the user device 112 having the display device 208 is merely provided as an exemplary implementation of the user device 112 of FIG. 1 and should not be construed as limiting for the scope of the disclosure. The present disclosure may also be applicable to other modifications, deletions, or additions to the display device 208, without a deviation from the scope of the present disclosure.

Embodiments described in the present disclosure may be used in many application areas, such as monitoring network traffic for potential threats without disrupting the network, unicast traffic, internal interface of any firewall (such as firewall 504). Further, the present disclosure may be used for fraud detection and intrusion monitoring. The present disclosure involves identification of data points or patterns in the time series data that may deviate significantly from the non-anomalous data. The present disclosure includes statistical analysis using neural network 104 to detect the time series anomaly using temporal correlation weights.

Various embodiments of the disclosure may provide one or more non-transitory computer-readable storage media configured to store instructions that, in response to being executed, cause a system (such as the system 102) to perform operations. The operations may include receiving a dataset comprising time series data. The operations may further include preparing, based on the dataset, a data input for a neural network comprising a first decoder, a second decoder, and an encoder connected to both the first decoder and the second decoder. The operations may further include generating, by applying the encoder to the data input, temporal embeddings, and sample temporal correlation weights of the data input. The operations may further include reconstructing anomalous time series data by applying the first decoder to the temporal embeddings. The operations may further include generating a first discriminator output by applying the second decoder to the temporal embeddings. The operations may further include feeding the anomalous time series data to the encoder to output anomalous temporal embeddings and anomalous temporal correlation weights of the anomalous time series data. The operations may further include generating a second discriminator output by applying the second decoder to the anomalous temporal embeddings. The operations may further include computing a divergence loss between the sample temporal correlation weights and the anomalous temporal correlation weights of the anomalous time series data. The operations may further include computing reconstruction losses based on the data input, the anomalous time series data, the first discriminator output, and the second discriminator output and training the neural network based on the divergence loss and the reconstruction losses.

As indicated above, the embodiments described in the present disclosure may include the use of a special purpose or general-purpose computer (e.g., the processor 202 of FIG. 2) including various computer hardware or software modules, as discussed in greater detail below. Further, as indicated above, embodiments described in the present disclosure may be implemented using computer-readable media (e.g., the memory 204 or the dataset 114 or data input prepared based on the dataset 114) for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the system 102. In some embodiments, the different components, modules, engines, and services described in the present disclosure may be implemented as objects or processes that execute on the system 102 (e.g., as separate threads). While some of the system 102 and methods described in the present disclosure are generally described as being implemented in software (stored on and/or executed by general purpose hardware), specific hardware implementations or a combination of software and specific hardware implementations are also possible and contemplated. In this description, a “computing entity” may be any system 102 as previously defined in the present disclosure, or any module or combination of modulates running on the system 102.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, executed by at least one processor, comprising:
receiving a dataset comprising time series data;
preparing, based on the dataset, a data input for a neural network comprising a first decoder, a second decoder, and an encoder connected to both the first decoder and the second decoder;
generating, by applying the encoder to the data input, temporal embeddings and sample temporal correlation weights of the data input;
reconstructing anomalous time series data by applying the first decoder to the temporal embeddings;
generating a first discriminator output by applying the second decoder to the temporal embeddings;
feeding the anomalous time series data to the encoder to output anomalous temporal embeddings and anomalous temporal correlation weights of the anomalous time series data;
generating a second discriminator output by applying the second decoder to the anomalous temporal embeddings;
computing a divergence loss between the sample temporal correlation weights and the anomalous temporal correlation weights of the anomalous time series data;
computing reconstruction losses based on the data input, the anomalous time series data, the first discriminator output, and the second discriminator output; and
training the neural network based on the divergence loss and the reconstruction losses.

2. The method according to claim 1, wherein the time series data is unlabeled data in a form of multivariate time series.

3. The method according to claim 1, wherein the preparation comprises:
performing data imputation on the time series data of the dataset to obtain refined time series data; and
dividing the refined time series data into windows of the refined time series data, wherein the data input includes the windows of the refined time series data.

4. The method according to claim 1, wherein the neural network includes:
the encoder and the first decoder together form a generator network, and
the encoder and the second decoder together form a discriminator network.

5. The method according to claim 1, wherein the application of the encoder to the data input includes:
generating graph embeddings with dynamic inter-feature correlations based on the data input; and
feeding the graph embeddings with the dynamic inter-feature correlations into an attention layer of the encoder to generate the temporal embeddings and the sample temporal correlation weights.

6. The method according to claim 5, wherein the temporal embeddings are graph temporal embeddings, the sample temporal correlation weights are sample temporal graph correlation weights, and the attention layer is a self-attention mechanism.

7. The method according to claim 1, wherein the anomalous temporal embeddings are anomalous graph temporal embeddings, and the anomalous temporal correlation weights are anomalous temporal graph correlation weights.

8. The method according to claim 1, wherein the divergence loss is a Kullback-Leibler (KL) divergence loss.

9. The method according to claim 1, wherein the reconstruction losses include:
a generator reconstruction loss between the data input and the anomalous time series data,
a first discriminator reconstruction loss between the data input and the first discriminator output, and
a second discriminator reconstruction loss between the data input and the second discriminator output.

10. The method according to claim 9, further comprising:
calculating a total generator loss as a weighted sum of the divergence loss, the generator reconstruction loss, and the second discriminator reconstruction loss; and
calculating a total discriminator loss as a weighted sum of the first discriminator reconstruction loss and a negative weighted sum of the divergence loss and the second discriminator reconstruction loss,
wherein the neural network is trained based on the total generator loss and the total discriminator loss.

11. The method according to claim 10, wherein the encoder includes a graph embedding generation block, a temporal embedding block, a temporal correlation weights block, and an anomalous temporal correlation weights block.

12. The method according to claim 11, wherein the training of the neural network includes:
updating weight parameters of the first decoder, the graph embedding generation block, the temporal embedding block, and the temporal correlation weights block by minimizing the total generator loss including the generator reconstruction loss and the second discriminator reconstruction loss; and
updating weight parameters of the anomalous temporal correlation weights block by minimizing the divergence loss.

13. The method according to claim 11, wherein the training of the neural network includes:
updating weight parameters of the second decoder, the graph embedding generation block, the temporal embedding block, and the temporal correlation weights block by minimizing the total discriminator loss and maximizing the second discriminator reconstruction loss; and
updating weight parameters of the anomalous temporal correlation weights block by maximizing the divergence loss.

14. The method according to claim 1, further comprising computing an anomaly score based on the divergence loss, the data input, the anomalous time series data, and the second discriminator output.

15. The method according to claim 1, further comprising:
acquiring input time series data from a user device;
feeding the input time series data to the trained neural network to compute an anomaly score of the input time series data;
comparing the anomaly score of the input time series data with a threshold score;
determining a class of the of the input time series data as one of anomalous data or non-anomalous data based on the comparison; and
controlling the user device to display a result including the anomaly score and the class.

16. One or more non-transitory computer-readable storage media configured to store instructions that, in response to being executed, cause a system to perform operations, the operations comprising:
receiving a dataset comprising time series data;
preparing, based on the dataset, a data input for a neural network that comprises a first decoder, a second decoder, and an encoder connected to both the first decoder and the second decoder;
generating, by applying the encoder to the data input, temporal embeddings and sample temporal correlation weights of the data input;
reconstructing anomalous time series data by applying the first decoder to the temporal embeddings;
generating a first discriminator output by applying the second decoder to the temporal embeddings;
feeding the anomalous time series data to the encoder to output anomalous temporal embeddings and anomalous temporal correlation weights of the anomalous time series data;
generating a second discriminator output by applying the second decoder to the anomalous temporal embeddings;
computing a divergence loss between the sample temporal correlation weights and the anomalous temporal correlation weights of the anomalous time series data;
computing reconstruction losses based on the data input, the anomalous time series data, the first discriminator output, and the second discriminator output; and
training the neural network based on the divergence loss and the reconstruction losses.

17. The one or more non-transitory computer-readable storage media according to claim 16, wherein the preparation comprises:
performing data imputation on the time series data of the dataset to obtain refined time series data; and
dividing the refined time series data into windows of the refined time series data, wherein the data input includes the windows of the refined time series data.

18. The one or more non-transitory computer-readable storage media according to claim 16, wherein the neural network includes:
the encoder and the first decoder together form a generator network, and
the encoder and the second decoder together form a discriminator network.

19. The one or more non-transitory computer-readable storage media 16, wherein the reconstruction losses include:
a generator reconstruction loss between the data input and the anomalous time series data,
a first discriminator reconstruction loss between the data input and the first discriminator output, and
a second discriminator reconstruction loss between the data input and the second discriminator output.

20. A system, comprising:
a memory storing instructions; and
a processor, coupled to the memory, which executes the instructions to perform a process comprising:
receiving a dataset comprising time series data;
preparing, based on the dataset, a data input for a neural network comprising a first decoder, a second decoder, and an encoder connected to both the first decoder and the second decoder;
generating, by applying the encoder to the data input, temporal embeddings and sample temporal correlation weights of the data input;
reconstructing anomalous time series data by applying the first decoder to the temporal embeddings;
generating a first discriminator output by applying the second decoder to the temporal embeddings;
feeding the anomalous time series data to the encoder to output anomalous temporal embeddings and anomalous temporal correlation weights of the anomalous time series data;
generating a second discriminator output by applying the second decoder to the anomalous temporal embeddings;
computing a divergence loss between the sample temporal correlation weights and the anomalous temporal correlation weights of the anomalous time series data;
computing reconstruction losses based on the data input, the anomalous time series data, the first discriminator output, and the second discriminator output; and
training the neural network based on the divergence loss and the reconstruction losses.
